(19) United States
(12) Patent Application Publication
(10) Pub. No.: US 2022/0167560 A1
(43) Pub. Date: Jun. 2, 2022

(54) LADEN WEIGHT ESTIMATION USING RFID TAGGED BALES

(71) Applicant: AGCO Corporation

(72) Inventors: Eric HERBERS, Hesston, KS (US); Grant Lewis GOOD, Moundridge, KS (US); Jason WIRE, Newton, KS (US); Mark GRIGSON, Stoneleigh (GB)

(21) Appl. No.: 17/445,466

(22) Filed: Aug. 19, 2021

Related U.S. Application Data
(60) Provisional application No. 63/119,604, filed on Nov. 30, 2020.

(51) Int. Cl. A01F 15/08; G09F 3/14

(52) U.S. Cl. CPC A01F 15/0825; G09F 3/14

(57) ABSTRACT

A method for identifying the weight of a transportation group of bales includes receiving, compressing and shaping crop material into a plurality of bales, wrapping each bale of the plurality of bales with a binding material and attaching an identification tag to each of the bales. A bale ID is crated for each bale and a weight value for each of the bales is associated with the bale ID of the respective bale. The identification tag on the bale for each bale is assigned to the bale ID. The method reads the identification tag of each of plurality of bales and assigns the plurality of bales to a transportation group with a local bale handling device. The plurality of bales in the transportation group are loaded onto a truck, and the total weight of the transportation group is determined by totaling the weight value of each bale in the transportation group.

### CROSS REFERENCE TO RELATED APPLICATION

This application claims the benefit of U.S. Provisional Application No. 63/119,604, filed Nov. 30, 2020, which is hereby incorporated by reference in its entirety.

### BACKGROUND OF THE INVENTION

### Field of Invention

The present disclosure is generally related to agricultural balers and, more particularly to a method and assembly for supplying bale identification tags to bales of agricultural crop material.

### Description of Related Art

Large square balers are used in the agricultural industry to create large substantially rectangular bales of crop material by moving over crop windrows to collect loose crop material, compress it, and form it into bales that are then bound and ejected. To that end, a baler is typically mechanically coupled with a tractor, and a power take-off (PTO) mechanism transfers power from the tractor's engine to drive the baler's operation. A rotary pick-up at the front of the baler collects the loose crop material and moves it into a feeder chute. Once the feeder chute is full, its contents are moved into a forming chamber. A reciprocating plunger compresses the crop material in the forming chamber into a growing bale. Once the bale reaches a predetermined length, which could be eight feet, it is tied and ejected through a discharge outlet to fall onto the ground behind the baler. The process then continues to create the next bale.

The weight of an individual bale can vary from the weight of other bales for a variety of factors, even if a baler is set to form bales having a desired target weight. Baler control systems that attempt to control bale weights often use simple algorithms that are based on the load on the plunger but that often fail to sufficiently control bale weights for various reasons, such as crop variations during field baling. Furthermore, these systems are primarily designed to protect the balers, and are only secondarily designed to have some ability to control bale weight. As a result, the weights of bales produced on the same day from the same crop in the same field may vary by more than one hundred pounds or even by several hundred pounds.

When loading bales on a truck for transport, it is difficult to estimate how much weight the truck has been loaded with, often requiring trucks to be weighed by a certified scale after loading. This action incurs extra time and cost into a bale handling operation. Overweight trucks can incur fines or be barred from travel. Operators may also be able to use load cells on the bale handling equipment to weigh bales, but this requires additional expensive hardware on the bale handling equipment and only keeps track of the weight handled by an individual loader, not the entire weight of a load. Thus, it is often time consuming and difficult to make sure the weight of the group of bales in a transport load is within the acceptable maximum weight limits. Therefore, there is a need for an improved ways to aid the user with planning loads for transportation.

### BRIEF SUMMARY OF THE INVENTION

Briefly stated, one aspect of the invention is directed to a method for identifying the weight of a transportation group of bales. The method includes receiving, compressing and shaping crop material into a plurality of bales, wrapping each bale of the plurality of bales with a binding material and attaching an identification tag to each of the bales. A bale ID is crated for each bale and a weight value for each of the bales is associated with the bale ID of the respective bale. The method assigns the identification tag for each bale to the bale ID. The method reads the identification tag of each of plurality of bales and assigns the plurality of bales to a transportation group with a local bale handling device. The plurality of bales in the transportation group are loaded onto a truck, and the total weight of the transportation group is determined by totaling the weight value of each bale in the transportation group.

This summary is provided to introduce concepts in simplified form that are further described below in the Description of Preferred Embodiments. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiment.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic diagram of an baler;

FIG. 2 is a schematic diagram of a bale bound with a binding material having a bale identification tag;

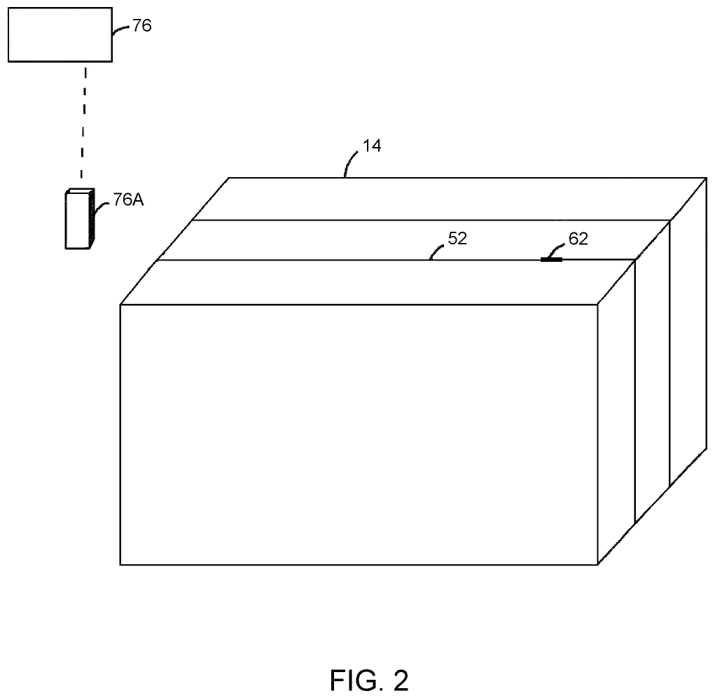

FIG. 3 is a schematic diagram of a truck carrying a transportation group of bales; and

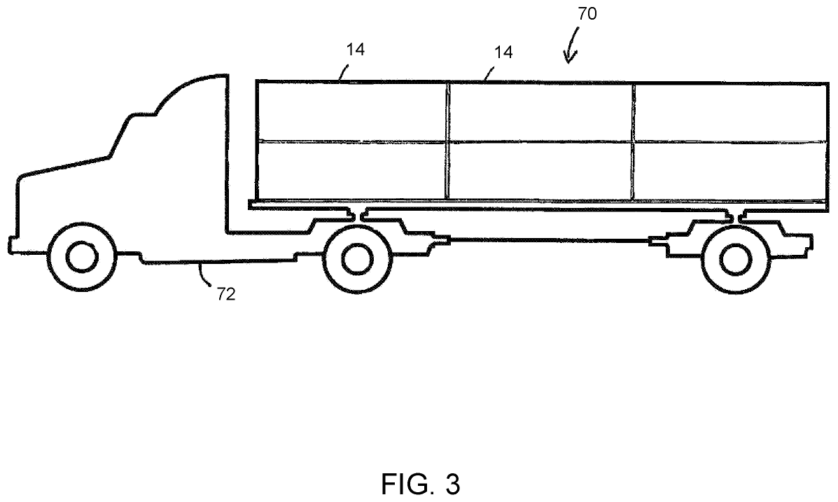

FIG. 4 is a flowchart of a method of grouping bales into a transportation group and determining the weight of the transportation group.

Corresponding reference characters indicate corresponding parts throughout the views of the drawings.

### DESCRIPTION OF PREFERRED EMBODIMENTS

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

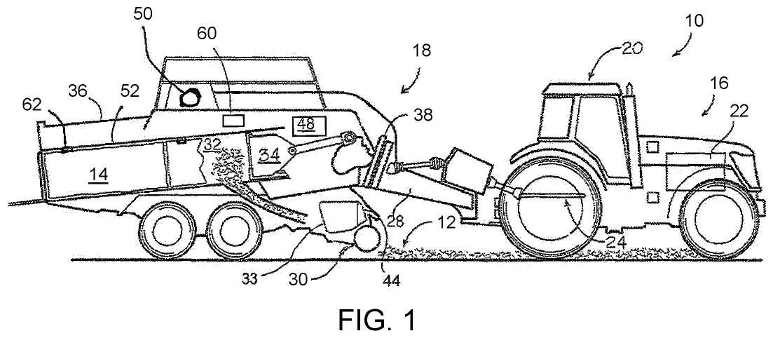

Referring now to FIG. 1, shown is a semi-schematic diagram of an agricultural baler system 10 which may be employed while baling loose crop material 12 from the ground into bales 14. The baler system 10 includes a towing vehicle 16 and a baler 18. The baler 18 is hitched to the towing vehicle 16 by a fore-and-aft tongue 28, and power for operating the various mechanisms of the baler 18 may be supplied by the PTO 24 of the towing vehicle 16, though not limited as such. One having ordinary skill in the art should appreciate in the context of the present disclosure that the example baler 18 is merely illustrative, and that other types of baling devices that utilize bale identification assemblies may be implemented.

The baler 18 has a fore-and-aft extending baling chamber denoted generally by the numeral 32 within which bales 14 of crop material 12 are prepared. A pickup assembly broadly denoted by the numeral 30 is positioned under the tongue 28 on the longitudinal axis of the machine, somewhat forwardly of the baling chamber 32. A stuffer chute assembly 33 is generally shown, and includes a charge forming stuffer chamber that in one embodiment is curvilinear in shape. In the particular illustrated embodiment, the baler 18 is an “extrusion” type baler in which the bale discharge orifice at the rear of the baler is generally smaller than upstream portions of the chamber such that the orifice restricts the freedom of movement of a previous charge and provides back pressure against which a reciprocating plunger 34 within the baling chamber 32 can act to compress charges of crop materials into the next bale as would be understood by one skilled in the art.

The plunger 34, as is known, reciprocates within the baling chamber 32 in compression and retraction strokes across the opening at the bottom of the baling chamber 32. The reciprocating plunger 34 presses newly introduced charges of crop material against a previously formed and tied bale 14 to thereby form a new bale. This action also causes both bales to intermittently advance toward a rear discharge opening 14 of the baler. The completed bales 14 are tied with binding material or a similar twine. Once tied, the bales are discharged from the rear end of the bale-forming chamber 32 onto a discharge in the form of a chute, generally designated 36.

The baler 18 may include one or more computing devices such as electronic control unit (ECU) 48. It will be understood that one or more ECUs 48 may be employed and that ECU 48 may be mounted at various locations on the towing vehicle 16, baler 18, or elsewhere. ECU 48 may be a hardware, software, or hardware and software computing device, and may be configured to execute various computational and control functionality with respect to baler 18 (or towing vehicle 16). As such, ECU 48 may be in electronic or other communication with various components and devices of baler 18 (or towing vehicle 16). For example, the ECU 48 may be in electronic communication with various actuators, sensors, and other devices within (or outside of) baler 18. ECU 48 may communicate with various other components (including other controllers) in various known ways, including wirelessly.

As the baled crop material 12 is formed in the baler 18, certain parameters or qualities of the crop material 12 or bale 14 such as moisture quality, baling time, bale weight, bale length, etc. may be measured or determined by the baler 18. One skilled in the art will understand how these crop or bale parameters may be measured using known sensors and techniques so further discussion of such sensors or measurement techniques need not be contained herein. Each measurement may be communicated to the ECU 48 for recording. The ECU 48 may communicate the detected measurement to a data server or other database for storage. The measurements may be stored locally via the data server or wirelessly communicated via a mobile device to a remote location over the cloud-based technology.

A knotter system 50 is configured to loop a binding material 52 around the finished bale 14. The term “binding material” as used herein is intended to mean not only twine made from natural or synthetic fibers, but may also include metallic wire or other strapping material. As knotter systems 50 are well known in the art, further description of the knotter system need not be included herein.

A bale identification assembly 60 is provided for assigning attributes of the crop material 12 and/or bale 14 to a bale identification tag 62 applied to the bale 14. Desirably, the bale identification tag 62 is a passive radio-frequency identification (RFID) tag used to electronically store information and collect energy from a nearby RFID reader's interrogating radio waves. As RFID tags are known to those skilled in the art, a detailed description of the RFID tag need not be provided herein. In embodiments of the present invention, the binding material 52 applied by the knotter system 50 is provided with bale identification tags 62. Bale identification tags 62 may be placed in the binding material 52 at certain intervals. In one embodiment, instead of storing bale attribute data directly to the bale identification tag 62, a bale ID for a given bale 14 is assigned to the identification tag 62 and attributes of that bale 14 such as weight, variety, location, moisture, feed value, mass flow, flake count, time of day, etc., are associated with the bale ID, which is then assigned to the identification tag 62 using software and a task controller post bale drop. The attributes and the bale tag identification number may be stored in a data server or database in an organized format so that it may be retrieved at a later time. For example, a user of a mobile device may access the data wirelessly via Wi-Fi, cloud-based technology or any other known communication means by accessing a server or database where the information is stored. In this manner, the data associated with any bale 14 may be tracked from a remote location at any given time. In one embodiment the bale identification assembly 52 and identification tags 62 are as described in commonly assigned U.S. Pat. No. 10,303,997 entitled Bale Identification Assembly for Binding and Identification Tag to a Bale of Agricultural Crop Material, which is incorporated herein by reference. However, one skilled in the art will understand that other bale identification tags and methods of associating bale attributes with the bale tag for a given bale may be used without departing from the scope of the invention.

According to the current invention, a plurality of bales 14 are formed into a transportation group 70 intended to be loaded onto a truck 72 or other transporting vehicle. Each bale 14 of the transportation group 70 has an identification tag 62 with a bale ID associated with the tag 62. A weight value 74 designating the weight of the bale 14 is associated with the bale ID for the bale that is assigned to the identification tag 62. A local bale handling device 76 can read the identification tag 62 to either obtain the weight value 74 of the bale 14 or use the tag identity to obtain the weight value 74 of the bale 14 from a computer storage device or remote server. The local bale handling device 76 reads the identification tag 62 for each bale 14 placed in the transportation group 70, associates each bale 14 as part of the transportation group 70, and obtains the weight value 74 of each of the bales 14 in the transportation group 70. The local bale handling device 76 determines an accumulated counter of the total weight of all of the bales 14 in the transportation group 70 to be loaded onto the truck 72. Alternately, the local bale handling device 76 communicates the information about the transportation group 70 to a remote server 76A that determines an accumulated counter of the total weight of all of the bales 14 in the transportation group 70 to be loaded onto the truck 72. Desirably, the local bale handling device 76 provides a display to the operator of an estimated laden weight of the transportation group 70 on the truck 72. Formation of the transportation group 70 may be shared with other local devices 76 through a direct or indirect wireless connection to allow multiple operators with multiple local devices 76 to load a single truck 72.

In one embodiment, when a new bale 14 is picked up and associated with the transportation group 70, the local bale handling device 76 may display the estimated laden weight of the truck 72 with the additional bale 14 included. The local bale handling device 76 may also warn the operator if the additional bale 14 may cause the truck 72 to exceed a maximum laden weight limit defined by the operator.

In one embodiment, the local bale handling device 76 or remote server 76A may keep track of what bales 14 have been loaded onto the truck 72 and allow an operator to view the laden weight of the transportation group 70 load by either selecting the load from a list or map, or scanning an individual bale 14 of the transportation group 70 to display details of the entire transportation group 70.

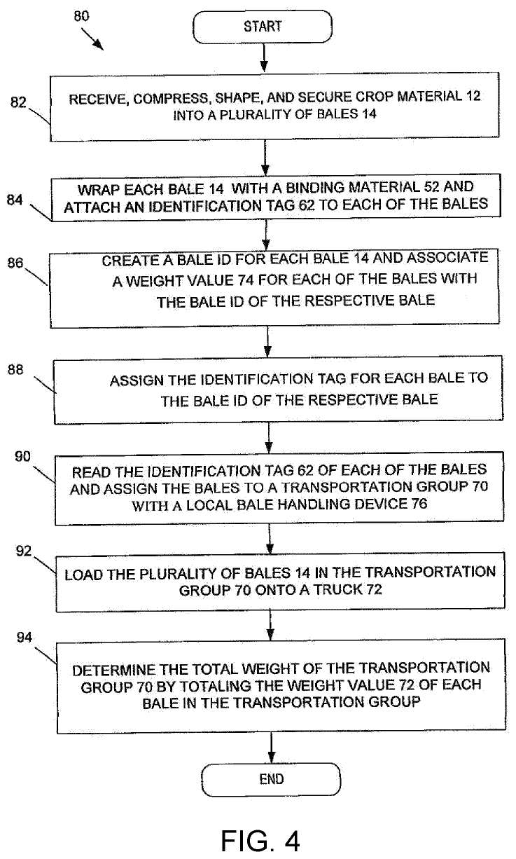

Referring also to FIG. 4, an embodiment of a method 80 is shown for determining the laden weight of a transportation group of bales loaded onto a truck 72. The method 80 may comprise some or all of the following steps, which may be implemented by components of the baler system 10 described above. As discussed, crop material 12 may be received and shaped and secured by a baler 18 into a plurality of bales 14, as shown in step 82. Each bale 14 is wrapped with a binding material 52 and an identification tag 62 is attached to each of the bales, as shown in step 84. A bale ID is created for each bale 14 and a weight value 74 for each of the bales is associated with the bale ID of the respective bale as shown in step 86. As shown in step 88, the identification tag 62 on the bale is assigned to the corresponding bale ID. The local bale handling device 76 reads the identification tag 62 of each of the bales and assigns the bales to a transportation group 70, as shown in step 90. The plurality of bales 14 in the transportation group 70 is loaded onto a truck 72, as shown in step 92. The total weight of the transportation group 70 is determined by totaling the weight value 74 of each bale in the transportation group, as shown in step 94.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A method for identifying the weight of a transportation group of bales comprising:
receive, compress and shape crop material 12 into a plurality of bales 14;
wrap each bale 14 of the plurality of bales with a binding material 52 and attach an identification tag 62 to each of the bales;
create a bale ID for each bale and associate a weight value 74 for each of the bales with the bale ID of the respective bale;
assign the identification tag for each bale to the bale ID of the respective bale;
read the identification tag of each of plurality of bales and assign the plurality of bales to a transportation group 70 with a local bale handling device 76;
load the plurality of bales in the transportation group onto a truck 72; and
determine the total weight of the transportation group 70 by totaling the weight value of each bale in the transportation group.
